(19) United States
(12) Patent Application Publication
(10) Pub. No.: US 2013/0342189 A1
(43) Pub. Date: Dec. 26, 2013

(54) ROTATIONAL DEVICE

(71) Applicant: Calvin Cox, Huddersfield (GB)

(72) Inventor: Calvin Cox, Huddersfield (GB)

(73) Assignee: Cummins Ltd., Huddersfield (GB)

(21) Appl. No.: 13/820,383

(22) PCT Filed: Sep. 6, 2011
(86) PCT No.: PCT/GB2011/001307

§ 371 Date: Jun. 3, 2013

(30) Foreign Application Priority Data
Sep. 6, 2010 (GB) 1014725.4
Mar. 12, 2011 (GB) 1104228.0

(51) Int. Cl. G01P 3/483

(52) U.S. Cl. CPC G01P 3/483
USPC 324/166

(57) ABSTRACT

A rotational device comprises a first portion, a rotatable body rotatable relative to the first portion and comprising at least one salient member, and a speed sensor arrangement for use in measuring a speed of rotation of the at least one salient member, the speed sensor arrangement comprises a signal electrode, at least a portion of which is located between the rotatable body and the first portion, there being an electric potential difference between the signal electrode and the first portion in use, the signal electrode being configured to output a first signal in use which is a function of the speed of rotation of the at least one salient member; a guard electrode, at least a portion of which is located between the signal electrode and the first portion, the guard electrode being separated from the signal electrode by at least a first electrically insulating portion, and the guard electrode being separated from the first portion by at least a second electrically insulating dielectric portion; and a buffer arrangement configured, in use, to provide a second electrical signal to the guard electrode; the second electrical signal being arranged to place the guard electrode at an electrical potential such that the potential difference between the signal electrode and the guard electrode is less than the potential difference between the signal electrode and the first portion.

The present invention relates to a rotational device comprising a speed sensor arrangement. Particularly, but not exclusively, the present invention relates to a turbomachine, such as, for example, a turbocharger, the turbomachine comprising a speed sensor arrangement for measuring the speed of rotation of a compressor wheel or a turbine wheel of that turbomachine.

Turbochargers are well known devices for supplying air to the intake of an internal combustion engine at pressures above atmospheric (boost) pressure. A conventional turbocharger typically comprises an exhaust gas driven turbine wheel mounted on a rotatable shaft within a turbine housing. Rotation of the turbine wheel rotates a compressor wheel mounted on the other end of the shaft within a compressor housing. The compressor wheel delivers compressed air to the intake manifold of the engine, thereby increasing engine power.

It is known to provide a turbocharger with a sensor arrangement to measure operating characteristics of the turbocharger, for example a speed of rotation of a turbine wheel of the turbocharger. Any such operating characteristics can be used as one parameter of a turbocharger control system, which may be in addition to or form part of an engine control system. The operating characteristic, for example the speed of rotation of a compressor wheel of the turbocharger, may be used to monitor, prevent or counteract any turbocharger over speeding or the like.

One type of speed sensor arrangement that is known comprises an electrode that is located in the vicinity of a turbine wheel, the speed of rotation of which is to be determined. The electrode may be mounted, for example, in a bore provided in the wall of the turbine housing which houses the turbine wheel. As the turbine wheel rotates, the electrode is able to detect perturbations as each blade of the turbine wheel sweeps past the electrode. The perturbations may be, for example, perturbations in capacitance, or perturbations in charge accumulated at the electrode, or perturbations in an electric field, for example, between the electrode and the turbine wheel, or the like.

Within and around a turbine housing, there may be a significant amount of noise. The noise may be generated by rotation of the turbine wheel itself, movement of one or more other parts of the turbocharger, or noise caused by, for example, the presence of electric fields in the vicinity of the electrode (e.g. due to a build up of static electricity), or electric currents flowing through the turbine housing or surrounding structures (e.g. a vehicle chassis). This noise reduces the signal-to-noise ratio at the electrode, which can make it difficult or impossible to accurately and/or consistently determine the nature (e.g. frequency or magnitude) of any perturbations. Consequently, the noise may make it difficult or impossible to actually and/or consistently determine the speed of rotation of the blade of the turbine wheel (or in general, a salient member of any rotatable body for which the speed sensor arrangement is used to measure the speed of rotation).

Furthermore, it is common for at least a portion of a turbocharger, when mounted (e.g. as part of an engine or other apparatus), to be earthed. That is to say that the portion of the turbocharger (for example its housing) has an electrical potential which is equal to an earth potential. The fact that the turbocharger is earthed does not necessarily mean that there is an electrical connection between the turbocharger and the ground (for example soil). For example, the turbocharger may be electrically connected to a terminal of a battery. In this context, the terms earth and ground may refer to a reference electric potential relative to which the voltage of other parts of the system may be measured. In this case earthed or grounded may refer to a component being at the earth or ground electric potential. In the aforementioned known turbochargers which comprise an electrode that is located in the vicinity of a turbine wheel, there may be an electrical potential difference between the electrode and the portion of the turbocharger which is earthed. The electrical potential difference between the electrode and the earthed portion of the turbocharger may cause charge leakage between the electrode and the earthed portion. Such charge leakage may adversely affect the performance of the speed sensor. For example, the charge leakage may reduce the signal to noise ratio of the speed sensor and thereby make the speed sensor less accurate in determining the speed of the rotating part of the turbocharger (e.g. the turbine wheel or compressor wheel).

It is an object of the present invention to provide a speed sensor arrangement for measuring the speed of rotation of a salient member of a rotatable body (e.g. a blade of a turbine wheel or compressor wheel) which obviates or mitigates a problem of the prior art, whether identified herein or elsewhere, or provides an alternative to prior art speed sensor arrangements.

According to a first aspect of the present invention, there is provided a rotational device comprising a first portion, a rotatable body rotatable relative to the first portion and comprising at least one salient member, and a speed sensor arrangement for use in measuring a speed of rotation of the at least one salient member, the speed sensor arrangement comprising a signal electrode, at least a portion of which is located between the rotatable body and the first portion, there being an electric potential difference between the signal electrode and the first portion in use, the signal electrode being configured to output a first signal in use which is a function of the speed of rotation of the at least one salient member; a guard electrode, at least a portion of which is located between the signal electrode and the first portion, the guard electrode being separated from the signal electrode by at least a first electrically insulating portion, and the guard electrode being separated from the first portion by at least a second electrically insulating dielectric portion; and a buffer arrangement configured, in use, to provide a second electrical signal to the guard electrode; the second electrical signal being arranged to place the guard electrode at an electrical potential such that the potential difference between the signal electrode and the guard electrode is less than the potential difference between the signal electrode and the first portion.

The first portion may be at a local earth potential in use.

The buffer arrangement may be configured, in use, such that the second signal experiences a lesser electrical impedance than the first signal.

The buffer arrangement may be configured to receive the first signal and provide the second signal to the guard electrode as a function of the first signal.

The first and second signal may have substantially the same voltage such that the potential difference between the signal electrode and the guard electrode is substantially zero.

The buffer arrangement may comprise an amplifier. The amplifier may be a unity gain buffer amplifier.

The signal electrode may be connected to a DC power supply, the DC power supply creating the potential difference between the signal electrode and the first portion.

The buffer arrangement may comprise an electrical connection between the DC power supply and the guard electrode. There may be a potential difference between the guard electrode and a locally earthed portion of the rotational device. The potential difference between the guard electrode and the locally earthed portion may create an electric field which may be referred to as a containment field.

At least one of the signal electrode and guard electrode may be part-annular. The guard electrode may be configured such that a straight line path, perpendicular to the signal electrode, between the signal electrode and the first portion passes through the guard electrode.

The signal electrode and guard electrode may be supported by an insert which is inserted into the rotatable device.

A third electrically insulating dielectric portion may be disposed upon the signal electrode, such that the third electrically insulating dielectric portion is between the signal electrode and the rotatable body.

The first portion of the rotational device may be a portion of a housing of the rotational device.

At least a portion of one of the signal electrode, guard electrode, first electrically insulating dielectric portion, second electrically insulating dielectric portion and third electrically insulating dielectric portion, if present, may be provided as a coating on a portion of the rotational device. Said portion of the rotational device is the first portion of the rotational device.

At least two of the signal electrode, guard electrode, first electrically insulating dielectric portion, second electrically insulating dielectric portion and third electrically insulating dielectric portion, if present, may form a stack in a radial direction, relative to an axis of rotation of the rotatable body.

The rotational device may be a compressor, turbine or turbocharger.

The rotatable member may be a compressor wheel or a turbine wheel, and the salient member may be a blade of that compressor wheel or turbine wheel.

According to a second aspect of the invention, there is provided a method of measuring a speed of rotation of a salient member of a rotatable body of a rotational device, the rotational device comprising a first portion; and a speed sensor arrangement having a signal electrode, at least a portion of which is located between the rotatable body and the first portion, a guard electrode at least a portion of which is located between the signal electrode and the first portion, and a buffer arrangement; the method comprising a rotation of the rotatable body; providing a first electrical signal to the signal electrode such that there is a potential difference between the signal electrode and the first portion; the buffer arrangement providing a second electrical signal to the guard electrode, the second electrical signal placing the guard electrode at an electrical potential such that the potential difference between the signal electrode and the guard electrode is less than the potential difference between the signal electrode and the first portion; the signal electrode outputting a output signal which is a function of the speed of rotation of the at least one salient member; and measuring the speed of rotation of the salient member using the variation in the output signal caused by rotation of the salient member.

Other advantageous and preferred features of the invention will be apparent from the following description.

Specific embodiments of the present invention will now be described, by way of example only, with reference to the accompanying Figures, in which:

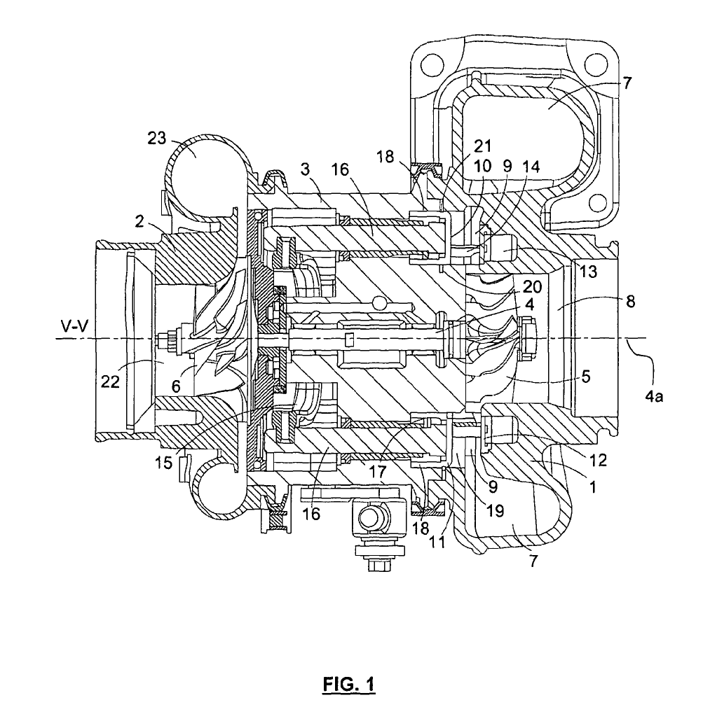

FIG. 1 schematically depicts an axial cross-section through a variable geometry turbocharger;

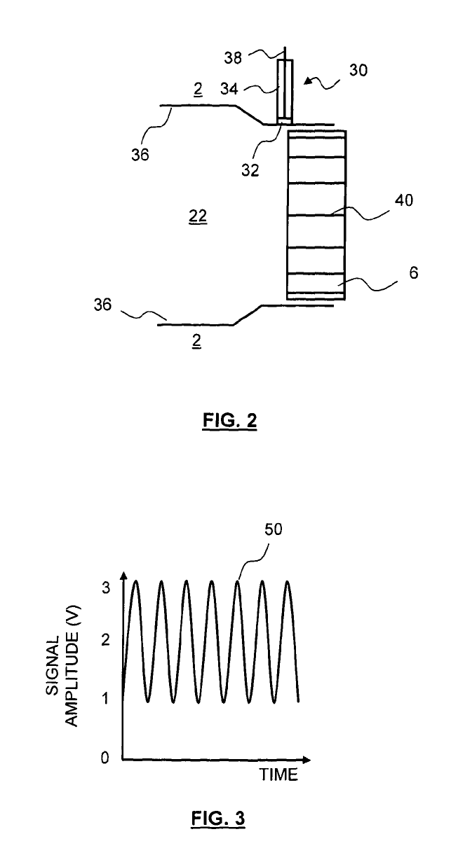

FIG. 2 schematically depicts a simplified view of part of the variable geometry turbocharger of FIG. 1, together with a known speed sensor arrangement;

FIG. 3 is a graph schematically depicting a first input provided by the speed sensor arrangement of FIG. 2;

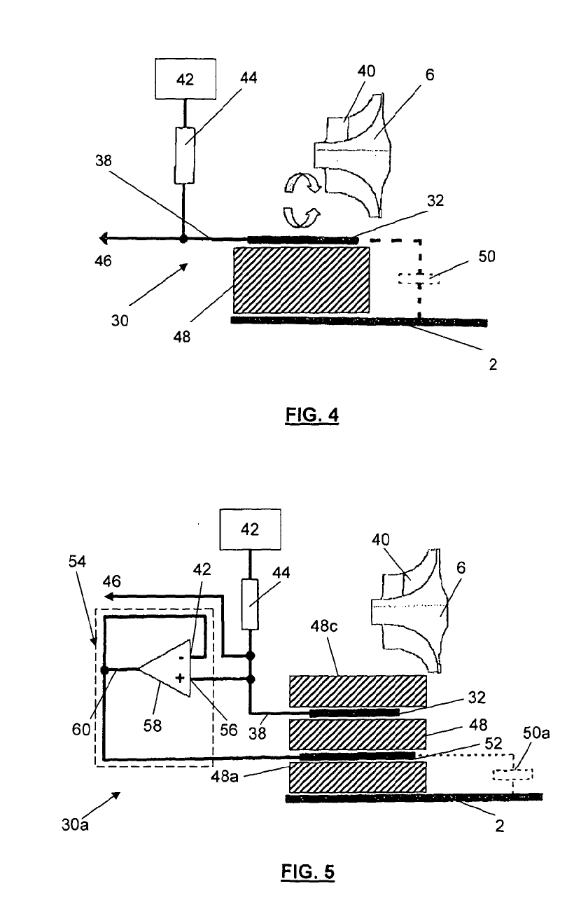

FIG. 4 schematically depicts another view of part of the turbocharger of FIG. 1, together with the speed sensor arrangement shown in FIG. 2;

FIG. 5 schematically depicts part of the turbocharger of FIG. 1 together with a first speed sensor arrangement, the turbocharger and first speed sensor arrangement being a rotational device according to a first embodiment of the invention;

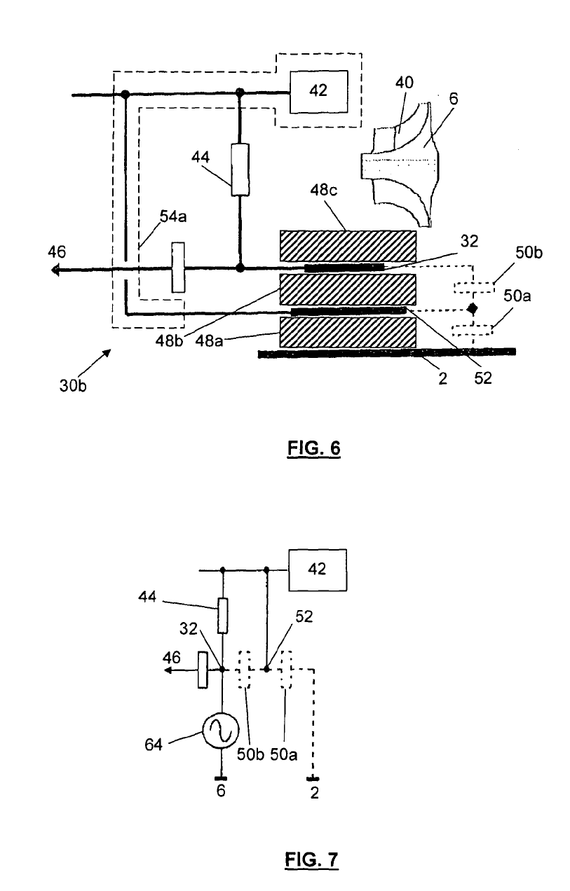

FIG. 6 schematically depicts part of the turbocharger of FIG. 1, together with a second speed sensor arrangement, the turbocharger and second speed sensor arrangement being a rotational device according to a second embodiment of the invention;

FIG. 7 schematically depicts an alternative representation of part of the rotational device shown in FIG. 6;

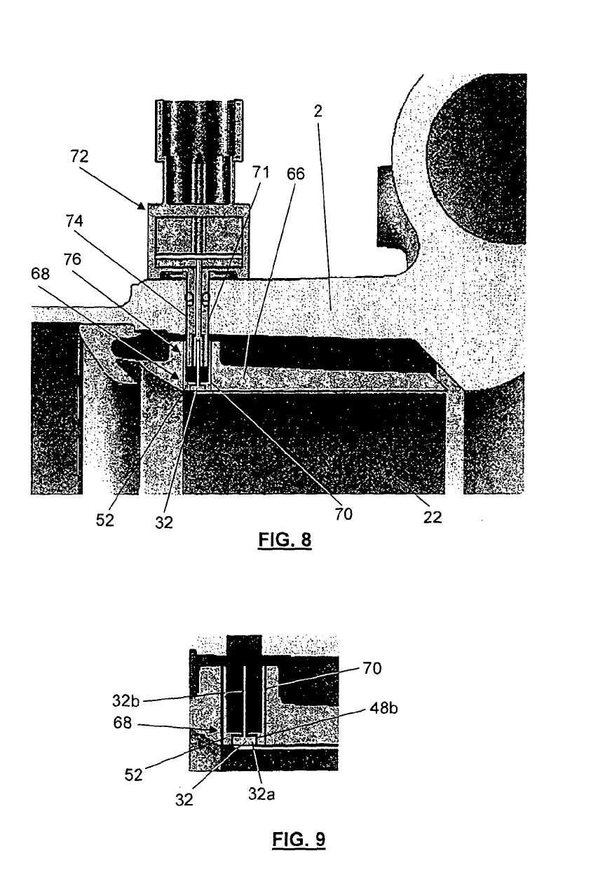

FIG. 8 shows a cross sectional view through part of a turbocharger which is a rotational device according to an embodiment of the invention; If this relates to the current claim then (32) is a connection to the electrodes which would be applied to the surface. In which case there would not be the ‘T’ section.

FIG. 9 shows an enlargement of an electrode assembly part of the turbocharger shown FIG. 8; as 8 with the electrode being the horizontal line in contact with the connection as in 10.

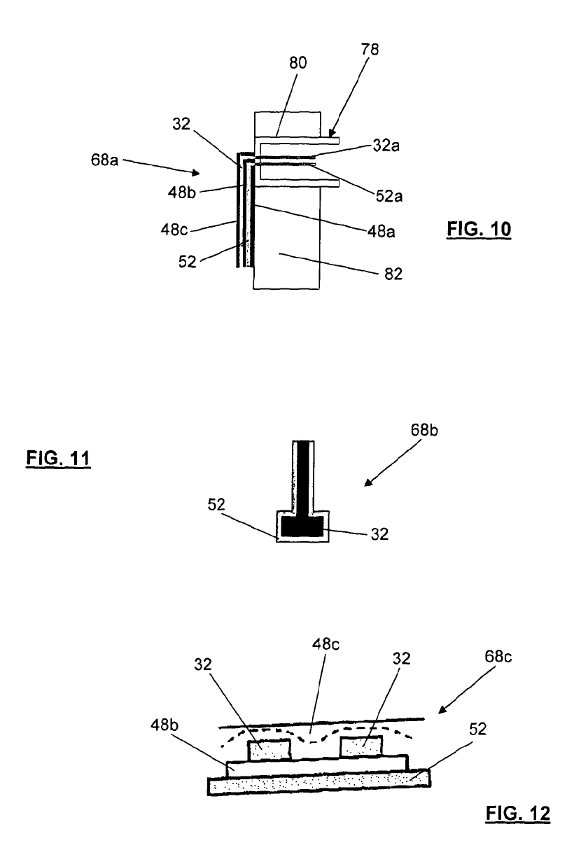

FIG. 10 shows a cross sectional view through an electrode assembly part of a rotational device according to a further embodiment of the present invention;

FIG. 11 schematically depicts part of an electrode assembly which may form part of a rotational device according to an embodiment of the present invention; and

FIG. 12 schematically depicts a cross section through part of a coated turbocharger which may form part of an electrode assembly of a rotational device according to an embodiment of the invention.

FIG. 1 illustrates a variable geometry turbocharger comprising a variable geometry turbine housing 1 and a compressor housing 2 interconnected by a central bearing housing 3. A turbocharger shaft 4 extends from the turbine housing 1 to the compressor housing 2 through the bearing housing 3. A turbine wheel 5 is mounted on one end of the shaft 4 for rotation within the turbine housing 1, and a compressor wheel 6 is mounted on the other end of the shaft 4 for rotation within the compressor housing 2. The shaft 4 rotates about turbocharger axis 4a on bearing assemblies located in the bearing housing 3.

The turbine housing 1 defines an inlet volute 7 to which gas from an internal combustion engine (not shown) is delivered. The exhaust gas flows from the inlet chamber 7 to an axial outlet passageway 8 via an annular inlet passageway 9 and turbine wheel 5. The inlet passageway 9 is defined on one side by the face 10 of a radial wall of a movable annular wall member 11, commonly referred to as a “nozzle ring”, and on the opposite side by an annular shroud 12 which forms the wall of the inlet passageway 9 facing the nozzle ring 11. The shroud 12 covers the opening of an annular recess 13 in the turbine housing 1.

The nozzle ring 11 supports an array of circumferentially and equally spaced inlet vanes 14 each of which extends across the inlet passageway 9. The vanes 14 are orientated to deflect gas flowing through the inlet passageway 9 towards the direction of rotation of the turbine wheel 5. When the nozzle ring 11 is proximate to the annular shroud 12, the vanes 14 project through suitably configured slots in the shroud 12, into the recess 13. In another embodiment (not shown), the wall of the inlet passageway may be provided with the vanes, and the nozzle ring provided with the recess and shroud.

The position of the nozzle ring 11 is controlled by an actuator assembly, for example an actuator assembly of the type disclosed in U.S. Pat. No. 5,868,552. An actuator (not shown) is operable to adjust the position of the nozzle ring 11 via an actuator output shaft (not shown), which is linked to a yoke 15. The yoke 15 in turn engages axially extending moveable rods 16 that support the nozzle ring 11. Accordingly, by appropriate control of the actuator (which may for instance be pneumatic or electric), the axial position of the rods 16 and thus of the nozzle ring 11 can be controlled.

The nozzle ring 11 has axially extending radially inner and outer annular flanges 17 and 18 that extend into an annular cavity 19 provided in the turbine housing 1. Inner and outer sealing rings 20 and 21 are provided to seal the nozzle ring 11 with respect to inner and outer annular surfaces of the annular cavity 19 respectively, whilst allowing the nozzle ring 11 to slide within the annular cavity 19. The inner sealing ring 20 is supported within an annular groove formed in the radially inner annular surface of the cavity 19 and bears against the inner annular flange 17 of the nozzle ring 11. The outer sealing ring 20 is supported within an annular groove formed in the radially outer annular surface of the cavity 19 and bears against the outer annular flange 18 of the nozzle ring 11.

Gas flowing from the inlet chamber 7 to the outlet passageway 8 passes over the turbine wheel 5 and as a result torque is applied to the shaft 4 to drive the compressor wheel 6. Rotation of the compressor wheel 6 within the compressor housing 2 pressurises ambient air present in an air inlet 22 and delivers the pressurised air to an air outlet volute 23 from which it is fed to an internal combustion engine (not shown). The speed of the turbine wheel 5 is dependent upon the velocity of the gas passing through the annular inlet passageway 9. For a fixed rate of mass of gas flowing into the inlet passageway, the gas velocity is a function of the width of the inlet passageway 9, the width being adjustable by controlling the axial position of the nozzle ring 11. FIG. 1 shows the annular inlet passageway 9 fully open. The inlet passageway 9 may be closed to a minimum by moving the face 10 of the nozzle ring 11 towards the shroud 12.

It may be desirable to be able to measure the speed of rotation of a turbine wheel of a turbocharger, for example, the turbine wheel of the turbocharger of FIG. 1.

FIG. 2 schematically depicts a part of the turbocharger of FIG. 1, together with a known speed sensor arrangement 30. A simplified view of the compressor wheel 6 is shown, together with the axial air inlet 22 and a part of the compressor housing 2. The speed sensor arrangement 30 comprises an electrode 32 which extends through a bore 34 provided in the compressor housing 2. The electrode 32 is adjacent to, forms part of, or extends from an internal wall 36 of the compressor housing 2. The electrode 32 may be in electrical connection with further electrical components via an electrical wire 38 or the like.

Rotation of the compressor wheel 6 causes blades 40 of the compressor wheel 6 to sweep or be swept past the electrode 32. The electrode 32 detects perturbations as a consequence of the passing of the blades 40. These perturbations may be perturbations in capacitance, electric field, charge gained or lost by the electrode or the like.

FIG. 3 is a graph schematically depicting a first input 50 that may be provided by the electrode of FIG. 2 to, for example, further electronics. The signal amplitude of the first input 50 varies periodically as a function of time. The periodicity may, for example, correspond to the timing of the passage of blades of a turbine wheel past the electrode, and thus the speed of rotation of the turbine wheel can be calculated from this periodicity. The signal amplitude may vary, for example, from 1V to 3V. The signal amplitude may vary as a function of, for example, electrode surface area, size and shape of the rotating salient member(s) (in this case the blades of the compressor wheel), and the magnitude of the containment potential (discussed below).

FIG. 4 shows a schematic view of the part of the variable geometry turbocharger shown in FIGS. 1 and 2. FIG. 4 also shows a schematic representation of the part of the electrical circuitry of the sensor arrangement 30. It can be seen that the electrode 32 is located between the compressor wheel 6 and the compressor housing 2. Both the compressor wheel 6 and compressor housing 2 may be at a local earth potential (sometimes referred to as a virtual earth). The term local earth potential may refer to a reference electric potential relative to which the voltage of other parts of the turbocharger may be measured. The compressor wheel 6 and compressor housing may be said to be at a local earth because the compressor wheel 6 and compressor housing 2 are electrically connected to the engine that the turbocharger is part of and the engine is electrically connected to a terminal of a battery. In this case, the electric potential of said battery terminal is at the electric potential relative to which the voltage of other parts of the turbocharger are measured (i.e. the local earth potential). The compressor wheel 6 and/or compressor housing may be electrical conductors. For example, they may be made of metal. However, in some embodiments, the compressor wheel 6 may be formed from an electrically insulating material such as a plastic material or a ceramic material. The electrode 32 is electrically connected to a DC (direct current) power supply 42 via a resistor 44. The DC power supply 42 creates a potential difference between the electrode 32 and the locally earthed portions (compressor wheel 6 and compressor housing 2) and hence creates an electric field between the electrode 32 and the locally earthed portions. The potential difference between the electrode 32 and the locally earthed portions may be referred to as the containment potential, and the electric field created by the containment potential may be referred to as the containment field. Perturbations in the electric field created by the electrode 32 may result in changes in the first input provided by the electrode to further electronics (as shown in FIG. 3). The first input provided by the electrode 32 to further electronics may be provided via a signal output 46. Perturbations in the electric field produced by the electrode 32 may be caused by blades 40 of the compressor wheel 6 sweeping past the electrode 32 and hence through the electric field between the electrode 32 and the locally earthed portions.

In order that a potential difference can be established between the electrode 32 and the compressor housing 2 (and compressor wheel 6), the electrode 32 is electrically isolated from the compressor housing 2 (and compressor wheel 6). The electrode 32 is electrically isolated from the compressor housing 2 (and the compressor wheel 6) by the presence of an electrically insulating material between the electrode 32 and the compressor housing 2 (and compressor wheel 6). The electrically insulating material between the electrode and the compressor wheel 6 is air from the compressor intake. The electrically insulating material between the electrode 32 and the compressor housing 2 takes the form of an insulator layer 48. The insulator layer 48 may be made of any appropriate electrically insulating material. For example, the insulator layer 48 may be formed from a plastic material or a ceramics material.

The insulator layer 48 is formed from a material which is not only electrically insulating, but also a dielectric material. Due to the fact that the dielectric insulator layer 48 is between the electrode 32 and compressor housing 2, the electrode 32, dielectric insulator layer 48 and compressor housing 2 may form a capacitor. This capacitor is indicated in dashed lines within FIG. 4 as 50. The capacitor 50 is shown linking the electrode 32 to the compressor housing 2. However, it will be appreciated that the capacitor 50 is shown within FIG. 4 only to aid understanding. The capacitor 50, as it is shown, does not exist. Instead, capacitor 50 represents the capacitor formed by the electrode 32, the dielectric insulator layer 48 and compressor housing 2. The capacitor 50 may allow charge to flow from the electrode 32 to the locally earthed compressor housing 2. The diversion of charge between the electrode 32 and compressor housing 2 may be referred to as charge leakage and may adversely affect the signal provided by the electrode 32 of the sensor arrangement 30 to the output 46. For example, charge leakage may reduce the amplitude of a signal provided at the output 46 of the sensor arrangement 30. Charge leakage occurs in a capacitor as the result of a leakage current through the dielectric (in this case the insulator layer 48). Normally, during the operation of a capacitor comprising two plates separated by a dielectric, it is assumed that the dielectric will effectively prevent the flow of current (i.e. the movement of charge) through the capacitor. This is because the dielectric commonly has a relatively high electric resistance. Although the resistance of the dielectric is relatively high, some current may flow through it causing charge leakage between the plates of the capacitor.

Furthermore, because charge leakage between the electrode 32 and compressor housing 2 may electrically couple the electrode 32 to the compressor housing 2, any interference in relation to the local electrical earth may be coupled from the locally earthed compressor housing to the electrode 32. Interference relating to the local earth may therefore negatively affect the signal provided to the output 46 of the sensor arrangement 30, and therefore negatively affect the accuracy of the speed measurement made by the sensor arrangement 30.

One of the objects of the present invention is to improve the operating performance of a speed sensor arrangement by preventing or substantially limiting charge leakage which occurs between the electrode 32 and the compressor housing 2.

FIG. 5 shows a schematic view of part of a first embodiment of the present invention. Where appropriate, the same numbering has been used for equivalent elements of the embodiment shown in FIG. 5 and elements shown in FIG. 4. A sensor arrangement 30a of this embodiment of the present invention differs from the sensor arrangement 30 shown in FIG. 4 in several ways. The sensor arrangement 30a has an additional guard electrode 52 which is located between the electrode 32 (which may be referred to as the signal electrode) and the compressor housing 2. In this case, the compressor housing 2 constitutes a first portion of the turbocharger. As previously discussed, the compressor housing 2 will, in use, be locally earthed and therefore be at a local earth potential. The sensor arrangement 30a also has first, second and third insulator layers 48a, 48b, and 48c. In a similar manner to the insulator layer 48 described in relation to the sensor arrangement shown in FIG. 4, the insulator layers 48a, 48b and 48c of the embodiment shown in FIG. 5 may be made of any appropriate dielectric, electrically insulating material. Preferably, the insulating material should have a low permittivity and high dielectric strength. An example of a suitable insulating material is Mylar®. Mylar® has a typical dielectric strength of about 7000 V per millimetre when exposed to an alternating electric field at a temperature of 25° C. Mylar® has a typical permittivity of about 3.2 times the permittivity of free space (∈₀), at a temperature of 25° C. and at a frequency of alternating electric field of 1 kHz.

The insulator layers 48a, 48b and 48c are located such that the first insulator layer 48a is situated between the compressor housing 2 and the guard electrode 52, the second insulator layer 48b is situated between the guard electrode 52 and signal electrode 32, and the third insulator layer 48c is situated between the signal electrode 32 and the compressor wheel 6. It will be appreciated that whilst the first and second insulator layers 48a and 48b form electrically insulating dielectric portions which contact their respective adjacent electrically conductive portions (compressor housing 2, guard electrode 52 and signal electrode 32), the third insulator layer 48c forms an electrically insulating dielectric portion which contacts the signal electrode 32, but does not contact the compressor wheel 6. It will be appreciated that this is because if the third insulator layer 48c contacted the compressor wheel 6, it may impede the rotation of the compressor wheel 6 and/or reduce air flow to the compressor wheel 6. This may negatively affect the performance of the compressor of the turbocharger. It will be appreciated that in some embodiments, the material from which the insulator layers 48a, 48b and 48c are formed may be a gaseous material (such as air). In the case where the third insulator layer 48c is formed from a gaseous material, the insulator layer 48c may contact the compressor wheel 6. In some embodiments the insulator layers 48a, 48b and 48c may each be formed from a plurality of materials. For example, the first and/or second insulator layers 48a and 48b may comprise a layer of material in a solid state (for example plastic or ceramics material) and a layer of material in a gaseous state (for example air).

The signal electrode 32 and guard electrode 52 are electrically connected to a buffer arrangement 54. The buffer arrangement 54 comprises a buffer amplifier 58. The signal electrode 32 is electrically connected to a first input 56 of the buffer amplifier 58. An output 60 of the buffer amplifier 58 is connected to a second input 62 of the buffer amplifier 58 and to the guard electrode 52. In the embodiment shown, the first input 56 of the buffer amplifier 58 is a non-inverting input (indicated by +) and the second input 62 is an inverting input (indicated by −). The buffer amplifier 58 acts such that it outputs a signal from output 60 which is substantially the same as the signal provided to input 56 by the signal electrode 32. Because the buffer amplifier 58 acts such that it outputs a signal which is substantially the same as an input signal (i.e. the input signal and output signal have substantially the same amplitude), the buffer amplifier may be referred to as a unity gain buffer amplifier.

Due to the fact that the output 60 of the buffer amplifier 58 is provided to the guard electrode 52, the guard electrode is held at an electric potential which is substantially the same as the electric potential of the signal electrode 32. Because the electric potential of the guard electrode 52 is substantially the same as the electric potential of the signal electrode 32 there is substantially no potential difference between the signal electrode 32 and the guard electrode 52. Due to the fact that there is substantially no potential difference between the signal electrode 32 and the guard electrode 52, there is substantially no electric field between the signal electrode 32 and the guard electrode 52. This means that there is substantially no charge moves between the signal electrode 32 and the guard electrode 52. As a result, there is very little charge leakage from the signal electrode 32 and hence the operating performance of the sensor arrangement 30a is improved compared to a sensor arrangement which does not comprise a guard electrode 52 and buffer arrangement 54.

The guard electrode may be held at an electric potential by the buffer arrangement such that an electric field is created between the guard electrode and a locally earthed portion of the compressor. This electric field may be referred to as a containment field. The containment field may enhance the effect of any perturbations caused by the rotation of the rotatable body (in this case the compressor wheel) for example, perturbations in an electric field, perturbations in capacitance, or perturbations in the accumulation or loss of charge in or on the electrode arrangements.

Although the compressor housing 2 is at a different electric potential with respect to the signal electrode 32, there is substantially no charge leakage between the signal electrode 32 and the compressor housing 2. This is because the guard electrode 52 is located between the signal electrode 32 and the compressor housing 2 and because the guard electrode 52 substantially nullifies any electric field which exists between the signal electrode 32 and the guard electrode 52 in the direction of the compressor housing 2. Because the electric field between the signal electrode 32 and the guard electrode 56 is substantially zero, there is substantially no force which may act on charges within the signal electrode 32 so as to cause charge leakage from the signal electrode 32 towards the compressor housing 2.

The buffer amplifier 58 produces an output signal 60 which is substantially the same as the signal that is provided to input 56 from the signal electrode 32. The use of the output of the buffer amplifier 58 to supply the guard electrode 52 (as opposed to the use of a direct connection to the signal electrode 32) may be beneficial because the use of the buffer amplifier 58 to create an electric potential will not draw any current from the signal electrode 32. Instead current will be drawn from the buffer amplifier 58, which may have a power supply that is isolated from the signal electrode 32. Due to the fact that the buffer amplifier 58 substantially draws no current from the signal electrode 32 in order to create the electric potential at the guard electrode 52, creating the electric potential at the guard electrode 52 has substantially no effect on the signal detected by the signal electrode 32. In the absence of the buffer amplifier 58, if significant current were to be drawn from the signal electrode 32 in order to power the guard electrode 52 (i.e. create an electric potential at the guard electrode 52) then the signal provided by the signal electrode 32 may be adversely affected such that it does not accurately reflect the speed of rotation of the compressor wheel 6.

The buffer amplifier acts so as to output a signal 60 to the guard electrode 52 which is substantially the same as the input 56 to the buffer amplifier 58 provided by the signal electrode 32. However, the signal which is produced by the buffer amplifier 58 at its output 60 experiences an electrical impedance which is less than that experienced by the signal provided to the input 56 of the buffer amplifier 58 by the signal electrode 32. Due to the fact that the buffer amplifier 58 establishes an electric potential at the guard electrode 52, and because the compressor housing 2 is at a local earth potential, there may be an electrical potential difference between the guard electrode 52 and the compressor housing 2. As previously discussed, because there is a potential difference between the guard electrode 52 and the compressor housing 2 there will be an electric field between the guard electrode 52 and the compressor housing 2. Due to the fact that there is an electric field between the guard electrode 52 and the compressor housing 2 and because they are separated by an insulator layer 48a which is formed from a dielectric electrically insulating material, the guard electrode 52 and compressor housing 2 will form a capacitor. The capacitor formed by the guard electrode 52 and compressor housing 2 is depicted by the capacitor 50a shown in dashed lines within the figure. Because the guard electrode 52, insulator layer 48a and compressor housing 2 form a capacitor, there may be charge leakage between the guard electrode 52 and the compressor housing 2. However, due to the fact that the impedance experienced by the signal provided to the guard electrode 52 is less than that experienced by the signal provided by the signal electrode 32, the current leakage between the guard electrode 52 and compressor housing 2 will be less than that between the signal electrode 32 and compressor housing 2 if the guard electrode 52 were not present.

As previously mentioned, the reason that the impedance experienced by the signal provided to the guard electrode 52 is less than that experienced by the signal provided by the signal electrode 32 is because the guard electrode 52 is powered by the buffer amplifier 58. Because the guard electrode 52 is powered by the buffer amplifier 58, any charge leakage which occurs between the guard electrode 52 and compressor housing 2 will draw current from the buffer amplifier 58 and not from the DC power supply 42 that supplies the signal electrode 32. It follows that charge leakage between the guard electrode 52 and compressor housing 2 will not affect the signal provided by the signal electrode 32 to the output 46 of the sensor arrangement 30a.

Although the described embodiment has a buffer arrangement that has a unity gain buffer amplifier, it will be appreciated that any appropriate amplifier may be used as part of the buffer arrangement.

It can be seen from the figure that the guard electrode 52 is larger than the signal electrode 32. Specifically, the guard electrode 52 extends such that it is longer in axial length than the signal electrode 32. This means that there is no straight line path, perpendicular to the signal electrode 32, between the signal electrode 32 and the compressor housing 2 that does not pass through the guard electrode 52. In other words, there is no radial path between the signal electrode 32 and compressor housing 2 which does not pass through the guard electrode 52. The larger size of the guard electrode 52 compared to the signal electrode 32 ensures that the guard electrode 52 substantially prevents any electric field between the signal electrode 32 and compressor housing 2 which is substantially perpendicular to the signal electrode 32 (i.e. radial). Because the larger size of the guard electrode 52 compared to the signal electrode 32 substantially prevents the formation of an electric field between the signal electrode 32 and compressor housing 2 which is substantially perpendicular to the signal electrode 32 (i.e. radial), charge leakage caused by movement of charge between the signal electrode 32 and compressor housing 2 in a direction substantially perpendicular to the signal electrode 32 (i.e. which is substantially radial) is substantially prevented. It follows that, because charge leakage caused by movement of charge between the signal electrode 32 and compressor housing 2 in a direction substantially perpendicular to the signal electrode 32 (i.e. which is substantially radial) is substantially prevented, the total amount of charge leakage between the signal electrode 32 and compressor housing 2 is reduced.

FIGS. 6 and 7 show different representations of part of a rotational device in accordance with a second embodiment of the present invention. This embodiment of the invention is very similar to that shown in FIG. 5. The same numbering has been adhered to throughout the figures for equivalent features. The embodiment shown in FIGS. 6 and 7 differs from the embodiment shown in FIG. 5 in that the buffer arrangement 54a of sensor arrangement 30b does not comprise a buffer amplifier, but rather a connection between the guard electrode 52 and the DC power supply 42. In a similar manner to the previously described embodiment, the electrical impedance experienced by the signal supplied by the buffer arrangement 54a to the guard electrode 52 is less than the impedance experienced by the signal provided by the signal electrode 32.

Due to the fact that the guard electrode 52 is connected to the DC power supply 42, the guard electrode 52 is held at substantially the same electric potential as the potential of the DC power supply 42. Because the guard electrode 52 is at substantially the same electric potential as the DC power supply 42 and because the DC power supply 42 also supplies power to the signal electrode 32, the electric potential difference between the guard electrode 52 and signal electrode 32 is small compared to the potential difference between the signal electrode 32 and the compressor housing 2. It follows that charge leakage between the signal electrode 32 and the guard electrode 52 is small compared to charge leakage between the signal electrode 32 and the compressor housing 2 in the absence of the guard electrode 52. In some cases, charge leakage between the signal electrode 32 and the guard electrode 52 is substantially prevented. As with the previous embodiment, this means that charge leakage between the signal electrode 32 and compressor housing 2 will also be substantially prevented. Charge leakage will occur in preference between the guard electrode 52 and compressor housing 2 due, at least in part, to the fact that the guard electrode 52 is closer the compressor housing 2 than the sensor electrode 32. As previously discussed, the guard electrode 52, first insulator layer 48a and the locally earthed compressor housing 2 form a capacitor. This capacitor is represented figuratively by the capacitor 50a, which is shown in dashed lines in FIGS. 6 and 7. In a similar manner, the signal electrode 32, second insulator layer 48b and guard electrode 52 form a second capacitor. This capacitor is represented figuratively by the capacitor 50b, which is shown in dashed lines in FIGS. 6 and 7. As previously mentioned, there may be substantially no charge leakage between the signal electrode 32 and guard electrode 52 (i.e. via the capacitor 50b) because there may be substantially no potential difference between the signal electrode 32 and guard electrode 52.

In some embodiments of the invention according to that shown in FIGS. 6 and 7 it has been found that the use of a guard electrode 52 which is electrically connected to the DC power source 42 that supplies the signal electrode 32 can reinforce (and thereby improve) the signal strength of the signal produced by the signal electrode 32. It has also been found that after a period during which the sensor arrangement 30b undergoes a stabilisation of the charge on the guard electrode 52 and compressor housing (and hence the electric field between the two), the guard electrode may suppress disturbances occurring in the potential of the locally earthed compressor housing which might otherwise cause a signal to be produced at the signal electrode 32.

As discussed in relation to the previous embodiment and as seen in FIG. 6, it is preferable for the guard electrode 52 to be larger than the signal electrode 32. In some embodiments it has been found to be beneficial for the guard electrode to be sized such that it extends outwards from the signal electrode by at least 1 mm in each direction for the guard electrode to function effectively. For example, in the case where the guard electrode and signal electrode are part annular, the guard electrode may extend at least 1 mm axially beyond the circumferential edges of the signal electrode.

FIG. 7 schematically depicts an alternative representation of part of the rotational device shown in FIG. 6. Elements of the rotational device are represented by electronic symbols. The guard electrode 52 and locally earthed compressor housing 2 are shown as being figuratively connected by the capacitor 50a (shown in dashed lines). The signal electrode 32 and guard electrode 52 are shown as being figuratively connected by the capacitor 50b (shown in dashed lines). Perturbations in the electric field between the compressor wheel 6 and the signal electrode 32 due to the rotation of the compressor wheel are represented by the AC power supply 64.

The embodiment of the invention shown in FIG. 5 may be referred to as having an active guard electrode, whereas the embodiment shown in FIG. 6 may be referred to as having a passive guard electrode. The embodiments shown in FIG. 5 may be referred to as having an active guard electrode due to the fact that the guard electrode 32 is connected to and powered by the buffer amplifier 58. The buffer amplifier 58 has its own power supply which is separate to that of the DC power supply 42. Furthermore, the signal provided to the guard electrode 52 varies so as to match the signal at the signal electrode 32. In contrast, the guard electrode 52 of the embodiment shown in FIG. 6, which may be referred to as being passive, is powered by the same DC power supply 42 which supplies the signal electrode 32. The signal provided to the guard electrode may not vary as a function of the signal at the centre electrode 32.

FIGS. 8 and 9 show a proposed way in which a signal electrode and guard electrode according to the present invention may be mounted within a compressor of a turbocharger. FIG. 8 shows a cross-sectional view through an upper part of an axial compressor inlet 22. An insert 66 is received within the axial compressor inlet 22 which is defined by the compressor housing 2. The insert 66 is preferably formed from an electrically insulating material so that the electrode 32 is electrically isolated from the local earth potential of the compressor housing 2. For example, the insert may be manufactured from a plastic or ceramic material. The insert 66 may be designed to carry out a variety of functions. For example, the insert 66 may form a noise baffle or a map width enhanced (MWE) structure. Alternatively, the insert 66 may merely support part of a speed sensor arrangement (e.g. an electrode assembly 68) according to the present invention.

In the embodiment shown in FIGS. 8 and 9, the insert 66 supports an electrode assembly 68. The electrode assembly 68 comprises the signal electrode 32, the insulating layer 48b and the guard electrode 52 according to either of the embodiments shown in FIGS. 5 and 6. The electrode assembly 68 is received by a radial aperture 70 in the insert 66.

Referring to FIG. 9, which is an enlargement of part of the turbocharger shown in FIG. 8, the electrode assembly 68 comprises the signal electrode 32 and the guard electrode 52. The signal electrode 32 has a generally ‘drawing pin’ shape in that it has an enlarged head 32a from which an elongate stem 32b extends generally radially outward. An electrically insulating dielectric material forms an insulator layer 48b between the signal electrode 32 and guard electrode 52. The guard electrode 52 is generally cylindrical. The guard electrode 52 is generally co-axial with the longitudinal axis of the stem 32b of the signal electrode 32. The guard electrode 52 generally surrounds the signal electrode 32. However, the signal electrode 32 and guard electrode 52 are arranged so that the head 32a of the signal electrode 32 extends into the inlet passage 22 of the turbocharger equally with the guard electrode 52. In the embodiment shown the signal electrode 32 and guard electrode 52 are such that they are flush with an internal surface of the insert 66. Due to the fact that the signal electrode 32 and guard electrode 52 are flush with an internal surface of the insert 66, the signal electrode 32 and guard electrode 52 do not create a significant disturbance in the airflow through the insert 66 in use. Disturbance of the airflow through the insert 66 may cause an unwanted disturbance in the electric field measured by the sensor electrode 32 and hence lead to inaccurate speed measurement of the compressor wheel by the speed sensor arrangement. It follows that disturbance of airflow through the insert may be undesirable in some embodiments. A front face of the signal electrode 32 is directed into the inlet passage 22 of the turbocharger. The guard electrode 52 does not extend between the front face of the signal electrode 32 and inlet passageway 22.

The part of the speed sensor arrangement shown in FIGS. 8 and 9 also has an insulator layer (not indicated in the figures and equivalent to the third insulator layer 48c shown in FIGS. 5 and 6) in use between the signal electrode 32 and the compressor wheel (not shown). The insulator layer may be formed, at least in part, from a solid electrically insulating material or may be formed from a gaseous insulating material (such as air) between the signal electrode 32 and the compressor wheel. The insert 66 forms at least part of another insulator layer. This insulator layer between the guard electrode 52 and the compressor housing 2 is equivalent to the first insulator layer 48a shown in FIGS. 5 and 6. For example, the insulator layer (which is equivalent to the first insulator layer shown in FIGS. 5 and 6) may comprise the insert 66 and an insulator coating 71.

A connector assembly 72 extends through an aperture 74 in the compressor housing 2 such that a plug arrangement 76 which forms part of the connector assembly 72 can make electrical connections with both the signal electrode 32 and guard electrode 52. The electrical connections made by the plug arrangement 76 enable the sensor electrode 32 and guard electrode 52 to be connected to a buffer arrangement (not shown) and any required power supply (not shown). The insulator coating 71 is formed from an electrically insulating material and is located intermediate the compressor housing 2 and the portion of the connector assembly 72 which is electrically connected to the guard electrode 52. The insulator coating may be coated on the connector assembly 72 and/or the portion of the compressor housing 2 which defines the aperture 74. The insulator coating 71 forms an insulator layer which substantially electrically insulates the compressor housing 2 from the portion of the connector assembly 72 which is electrically connected to the guard electrode 52. The insulator coating 71 ensures that connector assembly 72 does not facilitate any unwanted electrical connection between the signal electrode 32 or guard electrode 52 with the locally earthed compressor housing 2.

FIGS. 8 and 9 show a schematic example of a proposed embodiment of the invention. The embodiment shown in FIGS. 8 and 9 is for illustrative purposes only and provides an indication as to a possible way in which the invention may be carried out. It should not be taken to limit the invention in any way, the scope of which is defined by the claims.

FIG. 10 shows a cross sectional schematic representation of another electrode assembly 68a according to the present invention. The electrode assembly 68a comprises a connector assembly 78 which extends through an aperture 80 in a locally earthed portion 82 (such as a compressor housing). Again, the connector assembly 78 is formed from an electrically insulating material (such as a plastic material or a ceramics material). This ensures that connector assembly 78 does not facilitate any unwanted electrical connection between the signal electrode 32 or guard electrode 52 with the locally earthed compressor housing 2. The electrode assembly 68a comprises a signal electrode 32 and a guard electrode 52. Both the signal electrode 32 and guard electrode 52 have pin portions 32a and 52a respectively which form part of the connector assembly 78. The pin portions 32a and 52a may be used to facilitate electrical connection of the signal electrode 32 and guard electrode 52 with further electronics, which form part of a sensor arrangement which forms part of the present invention. A dielectric insulator layer 48a is disposed between the locally earthed portion 82 and guard electrode 52. A dielectric insulator layer 48b is disposed between the guard electrode 52 and signal electrode 32. A dielectric insulator layer 48c is disposed between the signal electrode 32 and rotating body (not shown) when the electrode assembly is installed. It can be seen that, as previously discussed, the guard electrode 52 is larger than the signal electrode 32. In this case, the guard electrode 52 has a greater length than that of the signal electrode 32.

FIG. 11 shows an overhead view of another possible electrode assembly 68b. The electrode assembly 68b has a generally T-shaped signal electrode 32 and a larger T-shaped guard electrode 52. The signal electrode 32 is stacked on top of the guard electrode 52 (such that they form a stack which extends out of the plane in which the figure is provided). Although not shown in the figure, the signal electrode 32 and guard electrode 52 are separated by a dielectric insulating layer.

In some embodiments of the invention at least one of the signal electrode, guard electrode and insulator layers may be applied to the turbocharger (or other rotational device) as a coating. FIG. 12 shows an electrode assembly 68c which comprises pair of signal electrodes which have been provided as a coating on part of a turbocharger. The signal electrodes 32 are provided as a coating on a portion of the turbocharger which is in proximity to the rotatable body, the speed of which is to be measured by the speed sensor arrangement. The signal electrodes 32 are located such that the rotation of the rotatable body (for example a turbine wheel or compressor wheel) will cause a perturbation in the electric field created by the sensor arrangement (or, for example, an ambient electric field).

In order to form the signal electrode 32 and guard electrode 52 of the electrode arrangement 68c shown in FIG. 12, the arrangement is formed layer by layer. First, a first insulator layer (not shown) is applied as a coating to part of the turbocharger (for example the compressor housing). The first insulator layer coating may be applied in the form of a fluid which may then dry naturally or be cured so as to form a layer of dielectric electrically insulating material. Once the first insulator layer is sufficiently dried/cured so that another coating can be applied to it, the guard electrode 52 may be applied as a coating to the first insulator layer. The guard electrode 52 coating may be formed from a conductive fluid (for example, an ink), although it will be appreciated that any appropriate material may be used providing that it dries/cures to form an electrically conductive layer. A second insulator layer 48b and the signal electrode 32 may be applied as coatings in a similar manner to that of the insulator layer 48a and guard electrode 52, as described above. A final insulator layer 48c may then be applied so as to coat the signal electrode 32. This insulator layer 48c may provide protection against abrasion, in use, due to airflow through the turbocharger and due to the rotation of the adjacent rotatable body. The insulator layer 48c may also provide protection from other environmental factors such as the high temperatures, which may be present within the turbocharger in use.

The electrically conductive and insulating layers which form the electrodes 32, 52 and insulator layers 48a, 48b and 48c may be applied using “thick film” techniques. In this case, each layer is applied as a fluid (e.g. an ink) and the finished coating is cured using high temperatures to complete a chemical reaction which results in the layers having the desired properties. One of the desired properties of the electrode layers may be that they are capable of carrying the electric signal which are provided to them. One of the desired properties of the insulator layers may be that they are capable of substantially preventing charge flow between respective electrodes and/or the compressor housing. It will be appreciated that any appropriate method may be used to apply the signal electrode, guard electrode and insulator layers to the housing of the turbocharger. For example, any appropriate coating technique may be used. In some embodiments, the signal electrode, guard electrode or insulator layers may be printed onto the compressor, or provided by another material (such as a film) which may then be mounted to the turbocharger housing (e.g. the compressor housing).

In embodiments in which the signal electrode, guard electrode, and/or insulator layers are printed onto part of the turbocharger housing, thick film inks may be used: a relatively conductive ink for the electrodes and a dielectric ink for the insulator layers. Thick film inks may typically operate at temperatures of up to 600° C. An example thickness of an electrode or insulator layer created using a thick film printing process is about 0.7 mm.

The insulator layer 48c which forms an outer coating may be polished or otherwise treated so as to reduce imperfections and/or increase the smoothness of the surface of the insulator coating 48c. This may help to reduce turbulence in any air which passes over the insulator layer 48c in use. A reduction in the turbulence of the air passing over the insulator layer 48c may improve the performance of the speed sensor arrangement because turbulence in the air may cause unwanted perturbations in the electric field which is measured by the sensor arrangement. The dashed line within FIG. 12 shows a possible profile of the insulator layer 48c once it has been polished. The solid line above the dashed line within FIG. 12, having regard to the orientation of figure, shows a further possible profile of the insulator layer 48c. In this case, in some embodiments the insulator layer 48c may have been polished, whereas in other embodiments, the insulator layer 48c may not have been polished. In some embodiments the insulator layer 48c may be formed from an appropriate material such that the speed sensor arrangement may function in conjunction with the passage of water or oil through the rotational device.

It will be appreciated that the signal electrode and guard electrode may have any appropriate shape and be arranged in any appropriate orientation and location within the turbocharger. For example, the signal electrode and guard electrode may be oblong and be arranged such that their longitudinal axes run substantially parallel to the axis of rotation of the turbocharger. Alternatively, the signal electrode and guard electrode may be arranged such that their longitudinal axes run partially around a circumference of the turbocharger (for example within the compressor inlet or turbine outlet).

Within the description above there is a potential difference between the signal electrode and the compressor housing. It is within the scope of the invention that, instead of the compressor housing, there may be a potential difference between the signal electrode and any appropriate portion of the turbocharger. For example, the portion of the turbocharger may not be the compressor housing, but rather any appropriate portion of the turbocharger (such as a portion of another part of the turbocharger housing). Alternatively, the portion may be a portion which is electrically isolated from the turbocharger (and hence compressor) housing.

The potential difference between the signal electrode and the first portion (e.g. compressor housing) of the turbocharger is described as being the potential difference between the potential of the signal electrode and the local earth (also known as virtual earth) potential of the first portion. The term local earth potential may refer to a reference electric potential relative to which the voltage of other parts of the turbocharger may be measured. The local earth potential may be the electric potential of a terminal of a battery. In order to for there to be a potential difference between the signal electrode and the first portion (such that an electric field exists between the two), the signal electrode and first portion will be at different electric potentials.

Within the illustrated embodiments, the signal electrode has been placed at an electric potential (which is different to the electric potential of the locally earthed portion) by a DC power supply. In some embodiments this need not be necessary. For example, the signal electrode may be placed at an electric potential which is different to that of the locally earthed portion, due to the creation and movement of charge which may be caused by the movement of the rotatable body. For example, charge created by the triboelectric effect as the rotatable body moves relative to the air may cause the signal electrode to be placed at a different electric potential to the local earth potential.

In some embodiments, at least a portion of the compressor housing may be formed from an electrically insulating material (for example, a plastic or ceramic material). In this case, use of a guard electrode in the manner discussed above may improve the signal strength of the signal produced by the signal electrode if the material from which said at least a portion of the compressor housing is formed is a poor dielectric.

In some embodiments the speed sensor arrangement may comprise a plurality of signal electrodes such as the electrode arrangements disclosed in WO 2011/023931, the contents of which is herein incorporated by reference. In embodiments in which there are a plurality of signal electrodes, there may be a plurality of guard electrodes. Each guard electrode may correspond to one or more signal electrodes. In the case where there are a plurality of guard electrodes, they may all be electrically connected to one another (e.g. they may be connected in parallel). Alternatively, in embodiments in which there are a plurality of signal electrodes, there may be a single guard electrode which corresponds to all of the signal electrodes. If a guard electrode corresponds to a signal electrode then the guard electrode may prevent or substantially limit charge leakage from the corresponding signal electrode.

Whilst the invention has been illustrated in its application to the compressor of a turbocharger, it will be appreciated that the invention can have other applications. In general, the speed sensor arrangement of the present invention may be suitable for use in measuring a speed of rotation of any appropriate salient member of a rotatable body. The rotatable body could be, for example, a turbine wheel or a compressor wheel. The salient member could be one or more blades of the turbine wheel or compressor wheel. The turbine wheel may form part of a turbine, for example a variable geometry turbine. The compressor wheel may form part of a compressor. The turbine and/or compressor may form part of a turbocharger or other turbomachinery, such as a power turbine. The turbocharger may form part of, or be in connection with, an internal combustion engine, for example an engine of an automobile.

Other possible modifications to the detailed structure of the illustrated embodiments of the invention will be readily apparent to the appropriately skilled person. Various modifications may be made to the embodiments of the invention described above, without departing from the present invention as defined by the claims that follow.

1-17. (canceled)

18. A rotational device comprising:
a first portion,
a rotatable body rotatable relative to the first portion and comprising at least one salient member, and
a speed sensor arrangement for use in measuring a speed of rotation of the at least one salient member, the speed sensor arrangement comprising:
a signal electrode, at least a portion of which is located between the rotatable body and the first portion, there being an electric potential difference between the signal electrode and the first portion in use, the signal electrode being configured to output a first signal in use which is a function of the speed of rotation of the at least one salient member;
a guard electrode, at least a portion of which is located between the signal electrode and the first portion, the guard electrode being separated from the signal electrode by at least a first electrically insulating portion, and the guard electrode being separated from the first portion by at least a second electrically insulating dielectric portion; and
a buffer arrangement configured, in use, to provide a second electrical signal to the guard electrode;
the second electrical signal being arranged to place the guard electrode at an electrical potential such that the potential difference between the signal electrode and the guard electrode is less than the potential difference between the signal electrode and the first portion.

19. A rotational device according to claim 18, wherein the first portion is at a local earth potential in use.

20. A rotational device according to claim 18, wherein the buffer arrangement is configured, in use, such that the second signal experiences a lesser electrical impedance than the first signal.

21. A rotational device according to claim 18, wherein the buffer arrangement is configured to receive the first signal and provide the second signal to the guard electrode as a function of the first signal.

22. A rotational device according to claim 21, wherein the first and second signal have substantially the same voltage such that the potential difference between the signal electrode and the guard electrode is substantially zero.

23. A rotational device according to claim 18, wherein the buffer arrangement comprises an amplifier.

24. A rotational device according to claim 23, wherein the amplifier is a unity gain buffer amplifier.

25. A rotational device according to claim 18, wherein the signal electrode is connected to a DC power supply, the DC power supply creating the potential difference between the signal electrode and the first portion.

26. A rotational device according to claim 25, wherein the buffer arrangement comprises an electrical connection between the DC power supply and the guard electrode.

27. A rotational device according to claim 18, wherein at least one of the signal electrode and guard electrode are part-annular.

28. A rotational device according to claim 18, wherein the guard electrode is configured such that a straight line path, perpendicular to the signal electrode, between the signal electrode and the first portion passes through the guard electrode.

29. A rotational device according to claim 18, wherein the signal electrode and guard electrode are supported by an insert which is inserted into the rotatable device.

30. A rotational device according to claim 18, wherein a third electrically insulating dielectric portion is disposed upon the signal electrode, such that the third electrically insulating dielectric portion is between the signal electrode and the rotatable body.

31. A rotational device according to claim 18, wherein the first portion of the rotational device is a portion of a housing of the rotational device.

32. A rotational device according to claim 18, wherein the rotational device is a compressor, turbine or turbocharger.

33. A rotational device according to claim 18, wherein the rotatable member is a compressor wheel or a turbine wheel, and the salient member is a blade of that compressor wheel or turbine wheel.

34. A method of measuring a speed of rotation of a salient member of a rotatable body of a rotational device, the rotational device comprising:
a first portion; and
a speed sensor arrangement having a signal electrode, at least a portion of which is located between the rotatable body and the first portion, a guard electrode at least a portion of which is located between the signal electrode and the first portion, and a buffer arrangement;
the method comprising:
a rotation of the rotatable body;
providing a first electrical signal to the signal electrode such that there is a potential difference between the signal electrode and the first portion;
the buffer arrangement providing a second electrical signal to the guard electrode, the second electrical signal placing the guard electrode at an electrical potential such that the potential difference between the signal electrode and the guard electrode is less than the potential difference between the signal electrode and the first portion;
the signal electrode outputting a output signal which is a function of the speed of rotation of the at least one salient member; and
measuring the speed of rotation of the salient member using the variation in the output signal caused by rotation of the salient member.
